(19) United States
(12) Patent Application Publication
(10) Pub. No.: US 2019/0370837 A1
(43) Pub. Date: Dec. 5, 2019

(54) Autonomous Article Evaluating, Disposing and Repricing

(71) Applicant: The Recon Group LLP, Miami, FL (US)

(72) Inventors: Sender Shamiss, Sunny Isles, FL (US); Donald T. Haynie, Hollywood, FL (US)

(73) Assignee: The Recon Group LLP, Miami, FL (US)

(21) Appl. No.: 16/429,162

(22) Filed: Jun. 3, 2019

Related U.S. Application Data
(60) Provisional application No. 62/680,135, filed on Jun. 4, 2018.
(60) Provisional application No. 62/680,540, filed on Jun. 4, 2018.

(51) Int. Cl. G06Q 30/02; G06Q 10/08

(52) U.S. Cl. CPC G06Q 30/0206; G06F 16/22; G06Q 10/087

(57) ABSTRACT

The present disclosure enables improvements in article evaluating, disposing and repricing uniquely-identified used articles. The invention comprises a system and a method for evaluating used articles, a system and a method for disposing used articles, and a system and a method for repricing used articles. Each system comprises a processor, a database and a computer-readable memory, which comprises a machine-learning algorithm. A unique identifier assigned to an article plays a crucial role in linking the systems and methods. A used article is fed into the evaluating system, which returns an evaluated article. Data on the evaluated article are fed into the disposing system, which returns a disposed article. For a disposed article to be listed for sale in an E-commerce marketplace, data on the disposed article are fed into the repricing system, which can reprice the article in response to market conditions. Each of the methods implements a machine-learning algorithm.

The present application claims the benefit of U.S. Provisional Patent Application Ser. Nos. 62680135 and 62680540, filed on 4 Jun. 2018, the contents of which are herein incorporated by reference in their entirety.

### FIELD OF THE INVENTION

The present disclosure relates to reverse logistics, and more particularly to the autonomous evaluating, disposing and repricing of used articles.

### BACKGROUND OF THE INVENTION

‘Reverse logistics’ means “the movement of goods from an original to a new final destination.” Often, the original final destination will be a first “end user,” a “consumer,” and the new final destination will be a second consumer, or perhaps a liquidator, refurbisher or parts harvester. In any case, the usual purpose of a reverse logistics process will be to capture some of the residual value of a good or ensure its proper disposal. Reverse logistics thus encompasses the thoughtful repurposing of products and reuse of manufacturing materials, both major concerns of “circular economics.”

Census Bureau data show that US retail sales currently amount to over $5 trillion per annum. E-commerce accounts for about 10% of the total. The economic significance of the reverse logistics of general consumer merchandise—which comprises iPhones, laptop computers, flat-screen televisions and other electronic devices—can be illustrated as follows. Returned general consumer merchandise has a current retail value of about $360 billion per year in the USA alone, according to 2017 data from credible sources (US government and industry experts) and accounting for all relevant disposition channels (destroy, return to vendor, liquidate/salvage, return to shelf, etc.). The E-commerce share of all retail sales has increased rapidly for over a decade; the trend is expected to continue. The current rate of return of general consumer merchandise in the USA is around 10% for brick-and-mortar store purchases and 3-fold higher for online purchases. A sharp reversal of consumer expectation regarding return policy must be considered improbable; the expectation is spreading from the USA to other major markets in the global economy. The fraction of the global population with internet access surpassed the 50% mark in early 2019 and is projected to keep rising.

A typical reverse logistics process for an article of consumer merchandise involves several steps. Generally executed in sequential order, the steps can comprise receiving an article in a return process, identifying the corresponding product based on the universal product code (UPC) of a returned article, assigning a unique identification code (UID) to an identified article, grading the condition of a uniquely-identified article, evaluating the salability of a graded article, and selecting a disposition pathway for an evaluated article (see FIG. 1). A common disposition pathway is a listing in a secondary E-commerce marketplace.

Grading, evaluating and disposing are themselves processes comprising several sequential steps each. Improving the realized recovery value of listed articles can involve adjusting prices by a process comprising several steps. Some such steps could involve a machine configured to operate autonomously. A machine in reverse logistics, to be useful, will enable either general facilitation of a multi-step process or specific execution of a step of a process.

The development of innovative devices, systems of devices, and methods of operating devices for grading, evaluating, disposing and pricing articles of returned consumer merchandise could lead to a variety of qualitative or quantitative improvements in present practices in reverse logistics. Possible improvements include a higher rate of article throughput, a more thorough approach to article handling when warranted, and a more cost-effective approach to article handling, leading to a shorter inventory dwell time and a higher recovery of value. Efficiency and scalability of technological improvements are growing concerns in the age of E-commerce.

Efforts to advance the burgeoning field of reverse logistics have been hampered by myopic forecasts, clunky technologies and systemic inefficiencies. Secondary markets for consumer merchandise had marginal economic significance—until recently. Consequently, few practitioners have been prepared to make effective use of the latest technologies, let alone develop their own. This posed a barrier to attracting talent and made it all the harder to attract talent. Many current reverse logistics practitioners are therefore mired in practices of a bygone era. On top of this, the field is struggling to cope with a massive uptick in returned goods. Key reverse logistics processes have become sclerotic, signaling systemic inefficiencies.

Further details are worth noting. Product grading is difficult, subjective and inconsistent. Cosmetic defects alone can span a broad range of actual conditions and thus translate into a broad range of justifiable prices and a high potential for failure to realize maximum recovery values. Product evaluation too is troublesome (FIG. 1, Step 3). Market value can be hard to gauge. Historical price data can be useful, but compilers are few and quality is patchy. Tens of millions of different consumer products are sold in the US every year; the accuracy and timeliness of data and data management have become serious concerns of reverse logistics. Choice of disposition pathway can be difficult (FIG. 1, Step 4). Some possible paths have multiple hidden costs, and estimating them accurately can be non-trivial. For example, preparing a unit of consumer electronics for sale in a secondary marketplace can involve not only grading but also cleaning and accessorizing. In general, accessorizing and cleaning cannot be automated, raising all the usual labor concerns. Some disposition costs can fluctuate in ways that are not obvious. Price adjustment in relation to temporal aspects of supply, demand and other market conditions can be tricky (FIG. 1, Step 6). In general, it will not be obvious how price might be adjusted to optimize value recovery.

The present invention comprises an autonomous means of evaluating items of returned or liquidated consumer merchandise. Automobiles and homes provide two useful examples for understanding some aspects of the present invention. The Kelley Blue Book is often used to evaluate automobiles in the secondary market. The values shown account for product (model and year), details (mileage, options and condition), market (real transaction data, what other buyers paid for the same make and model in comparable condition, supply, demand, regional variation in all noted market factors), sentiment (reviews), authority (expert opinion, industry knowledge) and comparative analysis (alternative products in related categories). A comprehensive view can provide a high level of confidence in an estimated value of a vehicle, enabling good decisions to be made about whether to keep the vehicle or not. Property appraisal in residential real estate resembles secondary-market automobile evaluation.

“Location, location, and location” are indeed “three” key concerns of real estate, but a sound appraisal process is more complex. A value estimate will generally be based on recent sale prices of comparable properties, ideally, similar structures in the same neighborhood. Appraisal will take due account of land area, heated/cooled area, year of construction, building materials, year and extent of additions and renovations, waterfront or not, pool or not, size of garage, age of appliances, style upgrades, etc. Other value adjustments may be justifiable. For example, the average value of property in the area could be rising or falling rapidly. In any case, one thus aims to have a good sense of the value of a property, so that good decisions can be made about whether to keep it or not.

For an automobile or a house, once the decision is taken to dispose of the asset, one must further determine which disposal route might be best to achieve a given aim. The aim could be to sell the asset at the highest possible price within a given time interval.

The present invention further comprises an autonomous means of selecting the best disposal option, or disposition, for items of returned or liquidated consumer merchandise. A process of this type will involve a comparison of estimated processing cost, estimated sale price and applicable recovery criteria. The estimated processing cost of an article often includes the costs of receiving, warehousing, picking, grading, cleaning and accessorizing, packing and shipping the article. Other costs are possible. There are many possible applicable recovery criteria, for example, 10% of manufacturer's suggested retail price (MSRP). Estimating the initial sale price of an article could be complex. Its distinctive character could hold much potential for technology development. Suppose there are just two disposition options. An item is classified for the one option if in the noted comparison the sum of the processing cost and recovery criterion does not exceed the estimated sale price, and for the other option if it does exceed it. In either case, additional decisions may be required to put selection of a unique disposition pathway for the article on a sound footing.

Trained artificial neural network/machine-learning (ANN/ML) systems are widely used for diverse purposes. These include autonomous system function, conversation and human interaction, goal-driven system function, hyper-personalization, pattern and anomaly detection, predictive analytics and decision making, and object recognition. Different approaches to image-based machine learning and training are known.

If a machine learning system will be used for evaluating, disposing or repricing used articles, various machine factors will impact the results obtained. These factors include quality of the ANN/ML algorithm, quality of the training dataset (number of different images, quality of images, and degree to which the images represent the space of all possible images), extent of ANN/ML system training (number of images used in ANN/ML system training, number of times the ANN/ML system has “seen” each image), related inaccuracies, likelihood of systematic error, and so on. The large number of relevant factors suggests there may be opportunities for advancing technology to achieve desirable outcomes in different aspects of article processing.

Potential advantages of an ANN/ML system for article evaluating, disposing or repricing include but are not limited to improved autonomy of the process, reduced subjectivity and therefore increased accuracy in evaluating, disposing or repricing, improved decision making based on data, increased time- and cost-effectiveness to achieve a specified performance criterion, and the ability to self-correct and thus improve in accuracy and outcome. These advantages can lead to improvements in determining costs throughout the supply chain, basing decisions on real-time or near real-time data, forecasting key metrics in supply chain logistics, selecting disposition channels, timing market entry, and recovering residual value of goods. An ANN/ML system, though necessarily imperfect, can be advantageous for redirecting human labor to higher-value activities, reducing or eliminating subjective aspects of decision making, and reducing article processing time. In short, the advantages of ANN/ML can outweigh the disadvantages in article evaluating, disposing and repricing.

For such reasons and others, it is desirable to develop improved systems and methods for automating and optimizing aspects of secondary goods processing. Despite recent advances in this area, further improvements are possible.

### SUMMARY OF THE INVENTION

In view of the foregoing, it is an object of the present disclosure to advance autonomous evaluating, disposing and repricing of used articles. In one aspect, the present invention comprises a system for evaluating a graded used article identified by a UID. The system comprises a processor, a database and a computer-readable memory. The processor is uniquely configured to receive pre-determined grade data for the used article, access graded used article-related data from at least one source, perform mathematical operations on quantitative data, and send data on the used article to at least one device. The database is uniquely configured to receive and store graded used article-related data from a plurality of sources. The computer-readable memory is uniquely configured to be capable of carrying out non-transitory computer-executable instructions to cause the processor to facilitate evaluating the used article, the computer-executable instructions comprising instructions that, when executed by the processor, implement one or more algorithms to acquire graded used article-related price and availability data from a plurality of sources and evaluate the graded and identified used article.

In another aspect, the present invention comprises a method of operating a system for evaluating a graded used article identified by a UID. The method comprises receiving into a processor pre-determined grade data for the used article in step, implementing computer code stored in memory to access, transfer and store in a database article-related price and availability data from a plurality of proprietary sources and a plurality of websites by application programming interfaces (APIs), implementing computer code stored in memory to access a plurality of websites containing article-related price and availability data, obtain a screenshot of each website, and transfer the screenshots to the processor, implementing a machine-learning algorithm and related computer code to parse the screenshot and identify the desired price and availability information in the parsed screenshot, using optical character recognition (OCR) or a related method to convert the desired price and availability information into corresponding character strings, evaluating the article by using the price and availability data obtained from proprietary databases and websites to compute an average price and an availability, and assigning the calculated price and the availability to the UID.

In another aspect, the present invention comprises a system for disposing a graded and evaluated used article identified by a UID. The system comprises a processor, a database and a computer-readable memory. The processor is uniquely configured to receive pre-determined evaluation data and margin data for the graded and evaluated used article, access graded and evaluated used article-related data and margin from at least one source, perform mathematical operations on quantitative data, and send data on the used to at least one device. The database is uniquely configured to receive and store graded and evaluated used article-related data from a plurality of sources. The computer-readable memory is uniquely configured to be capable of carrying out non-transitory computer-executable instructions to cause the processor to facilitate disposing the used article, the computer-executable instructions comprising instructions that, when executed by the processor, implement one or more algorithms to acquire evaluated used article-related cost data from a plurality of sources and assign a disposition pathway to the evaluated, graded and identified used article.

In another aspect, the present invention comprises a method of operating a system for disposing a graded and evaluated used article identified by a UID. The method comprises receiving into a processor pre-determined evaluation data and margin data for the graded and evaluated used article, implementing computer code stored in memory to access from databases data concerning the costs of processing graded used articles, specifically, the costs of cleaning, accessorizing, warehousing in a specific location, picking from a specific location, and the associated labor costs, implementing computer code stored in memory to access article-related cost data from websites by APIs, including shipping cost data, implementing a machine-learning algorithm to extract article-related cost data from screenshots, evaluating the cost of article processing by computing an average cost, and selecting a disposition pathway for the used article by comparing price, cost and margin, wherein the disposition pathways are at least two of one or more return-to-shelf processes, one or more return-to-vendor processes, one or more business-to-consumer marketplaces, one or more business-to-business marketplaces, one or more liquidators, one or more refurbishers, one or more parts harvesters, and one or more landfill sites.

In another aspect, the present invention comprises a system for repricing a graded, evaluated and disposed used article identified by a UID. The system comprises a processor, a database and a computer-readable memory. The processor is uniquely configured to receive pre-determined disposition data and parameter data for the graded, evaluated and disposed used article, access evaluated, graded and disposed article-related data from at least one source, perform mathematical operations on quantitative data, and send data on the used to at least one device. The database is uniquely configured to receive and store graded, evaluated and disposed used article-related data from a plurality of sources. The computer-readable memory is uniquely configured to be capable of carrying out non-transitory computer-executable instructions to cause the processor to facilitate repricing the used article, the computer-executable instructions comprising instructions that, when executed by the processor, implement one or more algorithms to compute a new daily price for the disposed, evaluated, graded and identified used article.

In another aspect, the present invention comprises a method of operating a system for repricing a graded, evaluated and disposed used article identified by a UID. The method comprises receiving into a processor pre-determined disposition data for the graded, evaluated and disposed used article, implementing computer code stored in memory to access UID-associated data from one or more computer storage locations, including all available historical daily price data for the used article in a specified time period, an initial quantity of like articles, a present quantity like articles, and pre-determined parameters used to calculate the daily price of the used article, calculating a weighted-average price of the used article over the specified time period based on the historical daily price data and a given method of weighting the contribution of each daily price in the specified time period, implementing a machine-learning algorithm to calculate a new daily price from the previous daily price, the weighted-average price, the number of units sold in a given time interval, and related parameters, and sending the new daily price to specified marketplaces.

Each of the present systems and methods involves a trained artificial neural network, concerns real products, and is used to produce concrete and tangible results, definite outcomes.

These and other objects, aspects and advantages of the present invention will be better appreciated in view of the drawings and following detailed description of preferred embodiments.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 shows a reverse logistics process for an article of consumer merchandise, highlighting evaluating (Step 3);

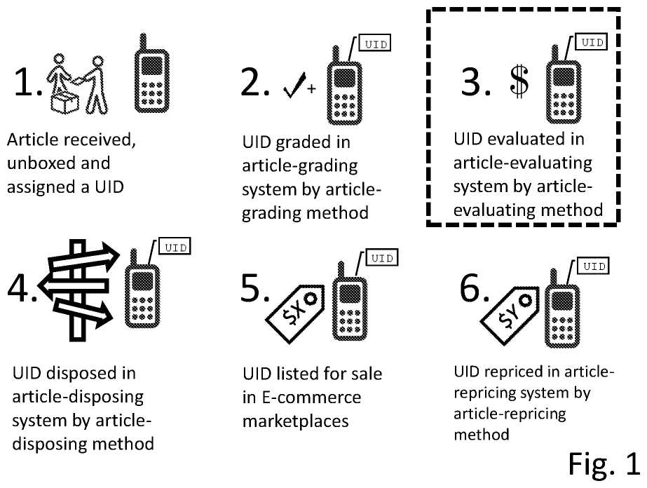

FIG. 2 shows a schematic view of a used article pricing process that involves a machine-learning system;

FIG. 3 shows a flowchart of an evaluating method of the present invention;

FIG. 4 shows a reverse logistics process for an article of consumer merchandise, highlighting disposing (Step 4);

FIG. 5 shows a flowchart of a disposing method of the present invention;

FIG. 6 shows a reverse logistics process for an article of consumer merchandise, highlighting repricing (Step 6); and

FIG. 7 shows a flowchart of a disposing method of the present invention.

### DETAILED DESCRIPTION OF PREFERRED EMBODIMENTS

The present invention and preferred embodiments thereof will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. Three sections, evaluation, disposing and repricing, are presented in turn.

Evaluating

‘Evaluating’, as used herein, means “initial pricing.” Here, the process of evaluating a used article can involve the use of an appropriate device to capture images of appropriate source material, using a pre-trained ANN/ML system to analyze the captured images, and storing the information obtained by this analysis on a generic computer. The use of an ANN/ML system is distinguished in evaluating from grading by the character of the data analyzed, the training focus of the ANN/ML system, and the result obtained from use of the ANN/ML system. In article grading, the images will be of an article to be graded, whereas in the present article evaluating system and method, the images will be screenshots, for example, of marketplace webpages pertinent to the article to be graded.

It is assumed that the present ANN/ML system for evaluating can be and has been trained to identify and extract desired information, or business intelligence, from screenshots, one region of an image at a time. The business intelligence thus gathered can comprise current price data, which can be combined with price data from other sources, inventory data, sales rate data, and other forms of data to estimate an initial price for a given article. The estimated initial price can then be used for different purposes, for instance, deciding whether to list the article in a business-to-customer marketplace or a business-to-business marketplace. The use of an autonomous article evaluating system promises improvements in the specificity, accuracy and/or completeness of the business intelligence identified in, and extracted from, diverse sources as the number of processed articles increases and thus improvements in the initial pricing of articles.

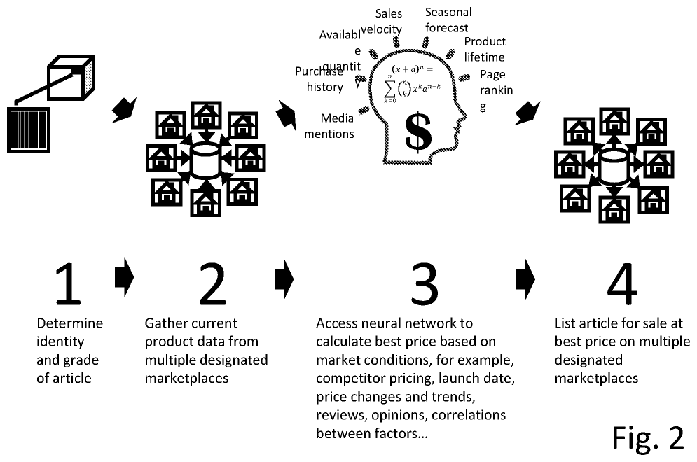

It is further assumed that the present used article evaluating process can be joined to related processes to achieve specific purposes (FIG. 2). In supply chain logistics for consumer merchandise in the secondary marketplace, for example, a process could involve determining the identity of an article, grading the article, gathering respective current product data (e.g. price information) from multiple designated marketplaces or proprietary databases structured and developed by any convenient method (e.g. autonomous data transfer and direct user input), determining an initial price for the article based on market conditions and other factors (e.g. competitor pricing, available quantity, sales velocity, page ranking, purchase history, product lifecycle, launch date, related and similar price changes and trends, historical trends and seasonality forecasts, sentiment and opinion mining from online reviews, media mentions, proprietary factors, correlations between factors), deciding based on the estimated value recovery whether to sell the article in a business-to-consumer or a business-to-business marketplace, and if specified criteria are met, listing the article for sale at the initial price on designated E-commerce websites. Reasons for, and a means of, repricing a marketplace-listed article are discussed below. Evaluating articles, or determining initial prices, is discussed here.

To the fullest possible extent, the foregoing descriptions of article evaluation and process integration involving article evaluation are to be viewed as specific embodiments of the present invention, which will now be described in detail.

In the present invention, a system 10 for evaluating a graded used article 20 identified by a UID 22 comprises a processor 30, a database 50, a computer-readable memory 70, and appropriate electrical communications connections. The processor 30 is uniquely configured to receive pre-determined grade data for the used article 20, access graded used article-related data from at least one source, perform mathematical operations on quantitative data, and send data on the used article to at least one device. The database 50 is uniquely configured to receive and store graded used article-related data from a plurality of sources, for example, marketplace webpages pertinent to the article to be graded. The computer-readable memory 70 is uniquely configured to be capable of carrying out non-transitory computer-executable instructions to cause the processor to facilitate evaluating the used article, the computer-executable instructions comprising instructions that, when executed by the processor, implement one or more algorithms to acquire graded used article-related price and availability data from a plurality of sources and evaluate the graded and identified used article 20.

In one embodiment, the processor 30 is further configured to compute quantities related to price and availability data, specifically, weighted averages, wherein a set of weighting factors used in the computation is pre-determined by the respective sources of information or determined in relation to product availability from the respective source of information.

In another embodiment, the database 50 is further configured to receive the price and availability data in a plurality of forms, including character strings and image files, by a plurality of methods, including direct user input by a user interface and autonomous data transfer by a device interface, and from a plurality of sources, including historical sales records in electronic format and websites containing webpages that feature product-related information.

In another embodiment, the plurality of sources of article-related price and availability data includes webpages, the content of which is acquired by connecting to an API and retrieving the desired data, or obtaining a screenshot of a webpage, parsing the screenshot, using a machine-learning algorithm 72 to identify the desired information in the parsed screenshot, and using OCR or a related method to convert the desired information into a corresponding character string.

In another embodiment, the processor 30 performs basic mathematical operations on the price and availability data obtained from proprietary databases and websites, computes an average price 32 and an availability 34 for the identified used article, and assigns the computed average price 32 and availability 34 to the UID 22.

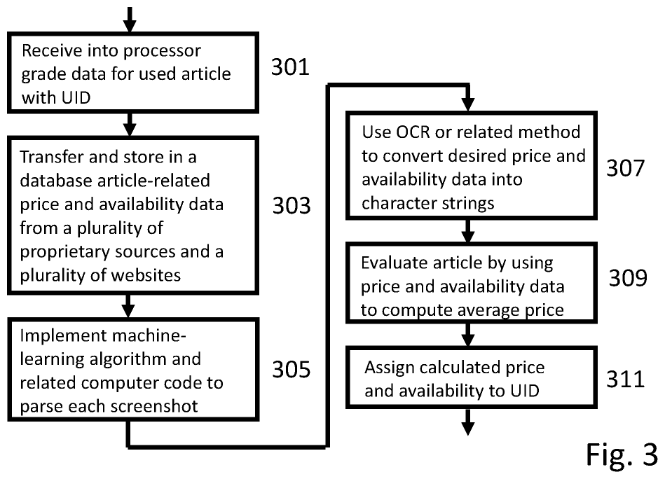

FIG. 3 shows a flowchart illustrating a method of operating a system 10 for evaluating a graded used article 20 identified by a UID 22. The method comprises receiving into a processor pre-determined grade data for the used article 20 in step 301, implementing computer code stored in memory 70 to access, transfer and store in a database 50 article-related price and availability data from a plurality of proprietary sources and a plurality of websites by APIs in step 303, implementing computer code stored in memory 70 to access a plurality of websites containing article-related price and availability data, obtain a screenshot of each website, and transfer the screenshots to the processor in step 305, implementing a machine-learning algorithm 72 and related computer code to parse each screenshot and identify the desired price and availability information in each parsed screenshot in step 307, using OCR or a related method to convert the desired price and availability information into corresponding character strings in step 309, evaluating the article by using the price and availability data obtained from proprietary databases and websites to compute an average price 32 and an availability 34 in step 311, and assigning the calculated price 32 and the availability 34 to the UID 22 in step 313.

An inventory management/marketplace listing (IM/MPL) system can comprise a means of evaluating articles. In a specific example, one that encompasses a specific embodiment of the present evaluating invention, the IM/MPL system comprises seven main components. One, a user interface, enabling meaningful interaction between the IM/MPL system and a user who lacks detailed knowledge of system operation. Two, a reliable means of reading a UPC displayed on an article and labeling the article with a UID when it enters the IM/MPL system. The article thus becomes associated with a UID and a product template comprising boilerplate information (e.g. a product description and nominal dimensions) and periodically refreshed data fields (e.g. MSRP, list price in marketplaces M₁, M₂ and M₃, and product availability in the same marketplaces). Three, sufficient computing capability and data storage capacity for frequent updates of key quantities, including product data available via an API and/or image capture and analysis of webpages. Four, an image-oriented ANN/ML system, for example, a convolutional or recurrent neural network, to identify desired business intelligence in captured webpages and extract the desired intelligence from the webpages, possibly combined with a character recognition system, to convert images of certain identified symbols into the corresponding Unicode characters. Five, a natural language processing ANN/ML system, to parse text from captured and processed webpages, for example, to evaluate sentiment. Six, a unified database, to enable advantageous utilization of extracted business intelligence and parsed text, historical pricing data, etc., for autonomous real-time responses to changes in product availability and other market conditions. Seven, continual improvement of the efficacy and accuracy of both ANN/ML systems.

Disposing

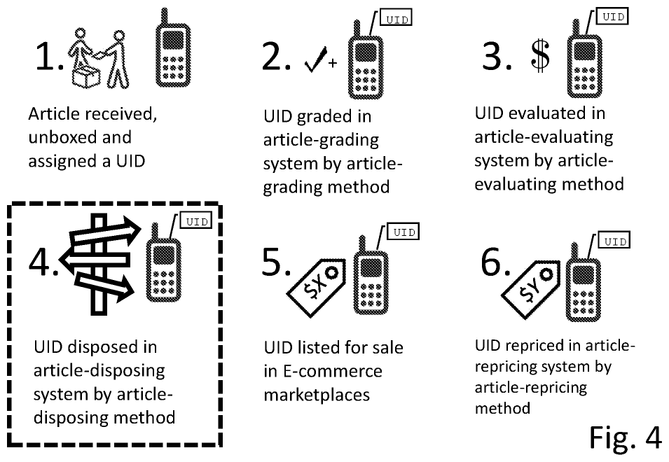

The present invention also concerns an autonomous approach to product disposing. Disposing' as used herein means “selecting a supply-chain channel in reverse logistics, for example, returning-to-shelf, returning-to-vendor, selling in a business-to-consumer (B2C) marketplace, selling in a business-to-business (B2B) marketplace, sending to a parts harvester, sending to a landfill or the like.” FIG. 4 shows a reverse logistics process for an article of consumer merchandise, highlighting disposing, Step 4.

In the present invention, a system 110 for disposing a graded and evaluated used article 120 identified by a UID 22 comprises a processor 130, a database 150, a computer-readable memory 170, and appropriate electrical communications connections. The processor 130 is uniquely configured to receive pre-determined evaluation data and margin data for the graded and evaluated used article 120, access graded and evaluated used article-related data and margin from at least one source, perform mathematical operations on quantitative data, and send data on the used to at least one device. The database 150 is uniquely configured to receive and store graded and evaluated used article-related data from a plurality of sources. The computer-readable memory 170 is uniquely configured to be capable of carrying out non-transitory computer-executable instructions to cause the processor to facilitate disposing the used article, the computer-executable instructions comprising instructions that, when executed by the processor, implement one or more algorithms to acquire evaluated used article-related cost data from a plurality of sources and assign a disposition pathway 132 to the evaluated, graded and identified used article 120.

In one embodiment, the processor 130 is further configured to compute quantities related to cost data, specifically, weighted averages, wherein the weighting factors are pre-determined by the respective sources of information, and quantities involving cost data, for example, net cost.

In another embodiment, the database 150 is further configured to receive cost data by a plurality of methods, including direct user input by a user interface and autonomous data transfer by a device interface, and from any useful source, for example, historical sales records in electronic format and websites containing webpages that feature product-related information.

In another embodiment, the plurality of sources of cost data includes webpages, the content of which is acquired by connecting to APIs and retrieving the desired data, or obtaining a screenshot of a webpage, parsing the screenshot, using a machine-learning algorithm 172 to identify the desired information in the parsed screenshot, and using OCR or a related method to convert the desired information into a corresponding character string.

In another embodiment, the processor 130 performs basic mathematical operations on the cost data obtained from proprietary databases and websites, computes an average cost for the graded and identified used article 120, and assigns a disposition 132 to the UID 122.

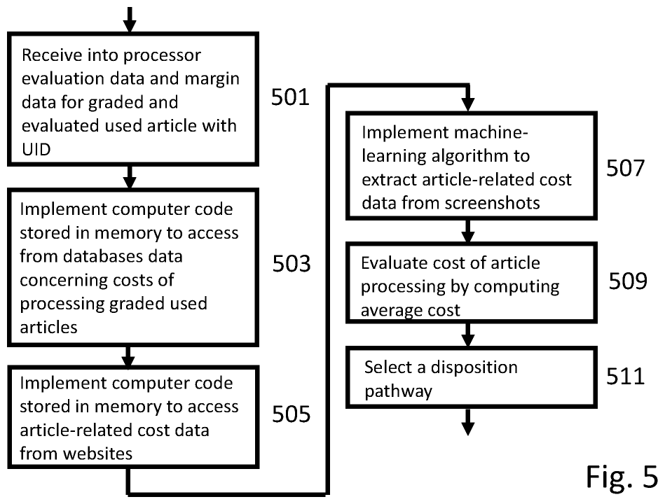

FIG. 5 shows a flowchart of a method of operating a system 110 for disposing a graded and evaluated used article 120 identified by a UID 22. The method comprises receiving into a processor 130 pre-determined evaluation data and margin data for the graded and evaluated used article 120 in step 501, implementing computer code stored in memory 170 to access from a database 150 data concerning the costs of processing graded used articles, specifically, the costs of cleaning, accessorizing, warehousing in a specific location, picking from a specific location, and the associated labor costs in step 503, implementing computer code stored in memory 170 to access article-related cost data from websites by APIs, including shipping cost data, in step 505, implementing a machine-learning algorithm 172 to extract article-related cost data from screenshots in step 507, evaluating the cost of article processing by computing an average cost in step 509, and selecting a disposition pathway 132 for the used article 120 by comparing price, cost and margin, wherein the disposition pathways are at least two of one or more return-to-shelf processes, one or more return-to-vendor processes, one or more business-to-consumer marketplaces, one or more business-to-business marketplaces, one or more liquidators, one or more refurbishers, one or more parts harvesters, and one or more landfill sites in step 511.

In one embodiment of the present disposing invention, an article will be categorized for B2C sale or B2B sale based on strict application of a 10% of MSRP recovery criterion. In another embodiment, the specified criterion is again 10% of MSRP, but in this case it leads to a recommended disposition, which a human then either accepts or rejects. If B2C sale, decisions must still be made about the marketplaces in which the article will be listed and when this should occur, and if B2B sale, decisions must still be made about how the article might be grouped with other articles, for example related articles, for sale or auction as a pallet comprising numerous individual articles. The complexity of the disposal process suggests that ways of improving its efficiency and effectiveness can be identified and addressed by technology development.

Repricing

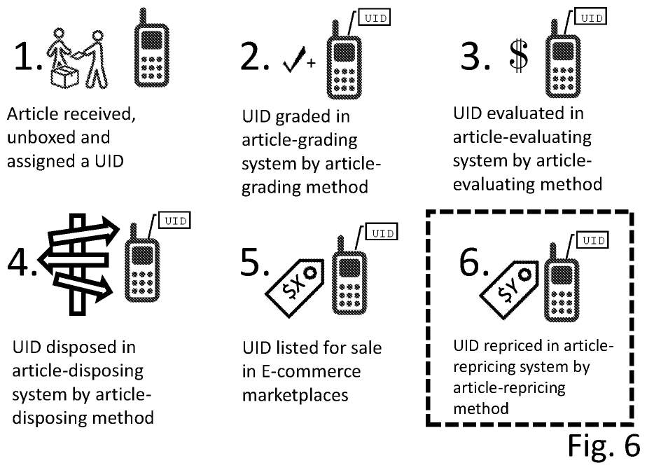

The present invention also concerns an autonomous approach to product repricing. As used herein, ‘repricing’, means “changing the price of an article listed for sale in at least one marketplace in response to factors that can influence sell-through, sales velocity, revenue and related quantities.” FIG. 6 shows a reverse logistics process for an article of consumer merchandise, highlighting repricing, Step 6.

Various online merchandisers are known to use algorithms to generate prices for their products. The approach can involve surveying prices for the same or similar products on different websites. Autonomous repricing can lead to different price-setting algorithms competing to find the lowest, most competitive price. A “cyberbattle” can send a reduced price back to MSRP, eliminating a cost advantage for consumers. This outcome can be realized by a trial-and-error search for a price by a reinforcement learning system when the system has no prior data descriptive of the environment in which it operates, no direct communication with other Al systems involved in price setting, and no specific design to cooperate or avoid cooperating with other Al systems. Reinforcement learning systems “learn” what “works” by a trial-and-error approach in the face of a challenge to be overcome.

A single online marketplace might have thousands, possibly tens of thousands, of different products listed for sale at a given time. One would like to know how all products could be priced, or how the prices could be adjusted in real time, to maximize revenue. There will be further challenges for a secondary marketplace. For there can be not only a multitude of different products, as in a primary marketplace, but also different conditions of a single product, and many possible reasons for assigning different articles to the same grade, even if the UPC is the same in all cases. In view of this, setting and adjusting price will be complex processes. There is yet another concern. Revenue will not invariably be the econometric quantity to be optimized. Instead, it could be value recovery, that is, the percentage of estimated recoverable residual value recovered for an item, or collection of items, in a secondary marketplace.

Often, the main aim of repricing will be to maximize revenue or a similar econometric quantity at every step of a time series. Repricing could be a decision linked to a prediction based on market conditions that recovered value will increase if a price is adjusted higher or lower. Consider, for example, a naïve repricing algorithm. If a product sells less quickly than a preset value, its price could be reduced to increase sales velocity, an indicator of the average sales rate. If, by contrast, the product sells more quickly than desired, its price could be increased to increase sales velocity. Sales rate and sales price are factors of sales velocity, which is pertinent to recovered value. What one would like to know, if it were possible, is how to optimize the price of each and every item for sale at every step of a time series to maximize overall sell through, recovered value, revenue, or some other related econometric quantity. Clearly, however, in general it will be impossible to gain such knowledge anywhere but in a computer simulation or analysis of historical data. A more realistic approach is to focus on sales velocity or factors thereof.

A technical point about pricing is worth noting. Mathematical optimization of a pricing function will be impossible except in the analysis of historical data, not in real time. There is no way to know whether a pricing function has reached an extreme value except in hindsight. However, if several nominally independent indicators have certain values or are positive or negative at the same time, it can significantly increase the likelihood that what might be an extremum is indeed an extremum. The situation is roughly the same in predicting when the price of stock, or economic growth, has reached a minimum or a maximum. Avoiding data “spikes,” or successive rapid changes in opposite directions, in inventory data and price data is crucial for reliable calculation; some averaging of data points is required. It is necessary to account for the aging of an article in inventory, or time to sell, and for the initial inventory and any inventory received in a given time interval.

In the present invention, a system 210 for repricing a graded, evaluated and disposed used article 220 identified by a UID 22 comprises a processor 230, a database 250, a computer-readable memory 270 and appropriate electrical communications connections. The processor 230 is uniquely configured to receive pre-determined disposition data and parameter data for the graded, evaluated and disposed used article 220, access evaluated, graded and disposed article-related data from at least one source, perform mathematical operations on quantitative data, and send data on the used to at least one device. The database 250 is uniquely configured to receive and store graded, evaluated and disposed used article-related data from a plurality of sources. The computer-readable memory 270 is uniquely configured to be capable of carrying out non-transitory computer-executable instructions to cause the processor to facilitate repricing the used article, the computer-executable instructions comprising instructions that, when executed by the processor, implement one or more algorithms to compute a new daily price 232 for the disposed, evaluated, graded and identified used article 220.

In one embodiment, the pre-determined disposition data include an initial price.

In another embodiment, the processor is further configured to compute quantities related to price, specifically, weighted-average prices and new daily prices, based on pre-determined price data, weighting factors, inventory values, elapsed time values, and parameter settings, assign a new daily price 232 to the UID 22, and send the new daily price 232 to at least one marketplace.

In another embodiment, the new daily price 232 is calculated by a machine-learning algorithm.

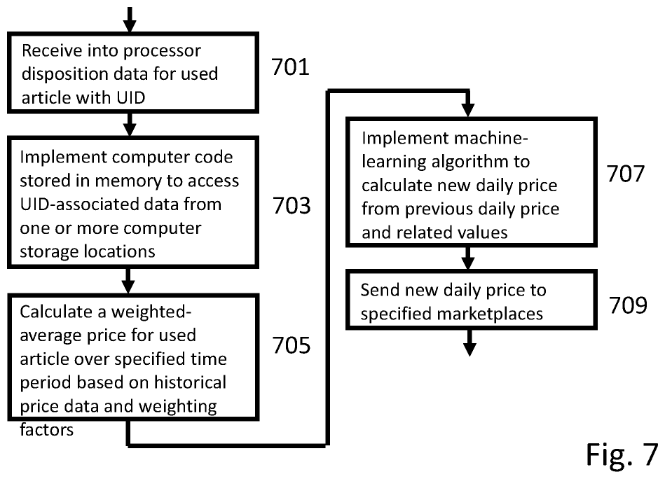

FIG. 7 shows a flowchart for a method of operating a system 210 for repricing a graded, evaluated and disposed used article 220 identified by a UID 22. The method comprises receiving into a processor 230 pre-determined disposition data for the graded, evaluated and disposed used article in step 701, implementing computer code stored in memory 270 to access UID-associated data from one or more computer storage locations, including all available historical daily price data for the used article in a specified time period, an initial quantity of like articles, a present quantity like articles, and pre-determined parameters used to calculate the daily price of the used article in step 703, calculating a weighted-average price of the used article over the specified time period based on the historical daily price data and a given method of weighting the contribution of each daily price in the specified time period in step 705, implementing a machine-learning algorithm 272 to calculate a new daily price 232 from the previous daily price, the weighted-average price, the number of units sold in a given time interval, and related parameters in step 707, and sending the new daily price 232 to specified marketplaces.

In one embodiment, the pre-determined disposition data include an initial price for the graded, evaluated and identified used article 220, the time when the article first entered inventory, the marketplaces where the article will be listed, and the times when listing of the article for sale is to begin for each marketplace.

In another embodiment, the machine learning system 272 is configured to accomplish one or both of maximizing revenue and maximizing recovery.

In another embodiment, the listing price is computed from a weighted average of the daily calculated price over a number of days.

An embodiment of the present invention is described as follows. The daily price of a product is calculated once in each successive 24-hour interval, accounting for the desired and actual number of sales, and a listing price is calculated, utilizing a weighted average of daily prices in a specified time interval. There are several parameters. These include S, a time period for price calculation, T, a target time period to sell all products (e.g. 45 days), Dₛ, an actual number of units sold on a given day, Qₛ, a target number of units to be sold per day, f, an empirical factor used to control daily price changes, pₛ*, a price calculated daily, and α, a sensitivity parameter. By definition, pₛ*=pₛ{f+[(1−f²)/f][Dₛ/(Q+Dₛ)}. Average price is then calculated as p*=Σwₛpₛ* for s≤S, where the weights wₛ˜log(1+s^{α})/s^{α} sum to 1. The sensitivity parameter is calculated as α=max[αₛαₑαₚ], where αₛ=log[1+d/QV(s)], d≈1.5 and QV(s)=(1/S)Σ(sᵢ−sᵢ₋₁)² for i=the last day for which statistics are not included to i=S−1 (this parameter increases with the stability of sales), αₑ=αₘₐₓc/(c+1), where αₘₐₓ≈4.5 and c=|1−Dₚ/Qₚ| (this parameter mirrors the difference between Qₚ and Dₚ in a short time period p), and αₚ=√[QV(p)/Var(p)], where Var(p) is the sample variance in price, QV(p) is the quadratic variation in price, and the average price is defined over all time points i from i=0 to i=S−1 (this parameter increases with significant purposeful movements of price). In one embodiment, the adjusted price is sent to the marketplaces at a pre-determined time of day in Universal Coordinated Time. In another embodiment, parameters are adjusted to optimize the price of low-inventory products, for example, ones for which the average daily inventory is less than ten units or the frequency of no units in stock is more than one day per year. In yet another embodiment, parameters are adjusted to optimize the price of rarely sold products, for example, ones for which the sales rate is less than one unit per day.

The following definitions are used herein:

‘Article’ means “a member of a class of things” and, more specifically, “a thing, often an item of merchandise, the exterior surface of which can display an optical, machine-readable representation of data, for example, a UPC.” ‘Article’ represents a certain replica of a product. An article could be an electronic device with a unique serial number and will have a certain grade. A product can be identified by a UPC and cannot have a certain grade. A synonym for ‘article’ in this context is ‘item’.

‘Artificial intelligence’ means “the so-called intelligent behavior displayed by some machines, for example, devices that can detect features of their surroundings, for example a field of view, respond, and thus increase the likelihood of success in achieving a goal with little or no human input.” Aspects of current interest in AI research include “machine reasoning,” data acquisition, data processing, data interpretation, “machine planning,” “machine learning,” natural language processing, “machine perception” and the ability of machines to move and manipulate objects, often autonomously.

‘Data science’ means “an interdisciplinary field that makes use of various scientific methods, theories and computer algorithms to extract knowledge and gain insights from data, whether structured or unstructured prior to analysis.”

‘Data mining’ means “using a computational approach to identify correlations of possible utility or value.” For example, data mining could reveal price/availability relationships between items, and this information could be used to predict price/availability changes in one item based on price/availability changes in a related item or estimate value of one item based on value of a related item.

‘Defect’ means “an imperfection in an article relative to what is typically considered ‘new’, for example, a scratch or dent.”

‘Dynamic self-learning’ means “a continual process of machine learning, wherein weighting factors between artificial neurons in an artificial neural network are continually adjusted in response to new data.” In the case of a classifier system, for example, the continual adjustment of weighting factors can increase the likelihood of correct autonomous classification.

‘Factor’ means “a circumstance, fact, trend or the like” that can influence a decision, for example, the influence of inventory on hand on the choice of initial sale price of an article.

‘Grade’ means “the condition of an article based on some number of cosmetic defect definitions.” A product with a high gloss surface, for example, is easily scuffed or scratched. Grade is generally considered a key determinant of the initial price of an article offered for resale. Often, a human expert will assign a grade to an article based on a direct assessment of physical condition, not technical functionality or performance. In the case of retail merchandise, for example, grade ‘A’ might signify an article in “excellent physical condition;” ‘B’, “good physical condition;” ‘C’, “fair physical condition;” and ‘D’, “poor physical condition.” The severity (typically, size and depth), number and location of cosmetic defects will influence grade. In the case of iPhones, for instance, an inspector will examine individual articles for blemishes, chips/nicks/gouges, cracks, “dead” pixels, dings/dents, pressure spots, scratches/scrapes, scuffs/abrasions, and screen burn/ghost images. Grading is subjective, but a high level of concurrence and article-to-article consistency can be achieved by well-trained human inspectors.

‘Grading’ means “assigning a grade to an article, whether it is done by a human or a machine.”

‘Imaging device’ means “a machine designed for capturing images, often based on photon reception in the visible range; for example, a camera.”

‘Intelligent decision engine’ means “a decision engine can optimize the execution performance of a ruleset.” A typical decision engine works in one of two ways. In one, the decision engine queries the user to specify criteria for detection or analysis in any given instance. The decision engine then provides a list of possibilities that match the user's criteria and possibly ranks the list. The user then selects from among these options. In the other, the decision engine collects data over time to establish a user's typical preferences.

‘Launch date’ means “the date a product first becomes available in a marketplace.”

‘Machine learning’ means “the training and/or use of an artificial neural network to accomplish a specified task,” for example, promote the success of autonomous business intelligence gathering on known factors or implement new factors to improve automated methods.

‘Machine vision’ means “all technologies and methods used to extract information from an image.” The information extracted can be simple, for example, a good-part/bad-part signal, or complex, for example, the identity, position and orientation of each object in an image. A machine vision process will generally involve acquiring an image, transferring the image data, employing digital image processing methods, extracting the desired information, and in some cases basing decisions on the extracted information. The process will generally utilize appropriate illumination, usually with photons, one or more imaging devices (e.g. cameras), one or more image processors, related software, and one or more output devices. The sequence of image processing will generally comprise applying filters, extracting articles, extracting data from the articles and communicating data. Automate article identification and utilize images for autonomous grading.

‘Natural language processing’ means “the programming of computers to process and analyze large amounts of natural language data, including speech recognition and natural language understanding.”0 A natural language processing system can automate analysis of textual data sources, e.g. user comments, making them a major source of information for pricing.

‘Neural network’, or ‘artificial neural network’ means “a computer system modeled on the human brain and nervous system. Automate grading and improvement of automated grading.”

‘Pricing’ means “the process whereby the price of a product is set.”

‘Product life cycle’ generally means “the stages a product goes through from when it is first conceived until it is removed from the market, though more generally the definition can include the entry of a product into the secondary market and other possibilities up until being destroyed.”

‘Proprietary/internal factors’ means “pricing rules, discounting rules, seasonal adjustments and the like; and it can include decisions related to warehouse availability, product aging, supplier-related delays in shipments and the like.”

‘Purchase history’ means “a record and possibly a means of tracking and managing all items purchased.”

‘R1’ means “a proprietary software program for inventory management and related functions in supply chain reverse logistics.”

‘Recovery’ is a comparison of the actual sale price of an article and a typical retail price of the article, for example, MSRP.

‘Sales velocity’ means “a sales metric influenced by four factors: v=ndw/Δt.” Here, v is sales velocity, n is number of sales opportunities, d is the average deal value, w is the average success rate, and Δt is the time interval.

‘Secondary market’ means “a post-retail supply chain channel that provides an outlet for unwanted goods from the primary market so that they can be bought and sold.”

‘Self-parsing machine learning’ means “the autonomous analysis of a string of symbols according to rules. In computer science, the term is used in the analysis of computer languages, where it refers to the syntactic analysis of the input code into its component parts or describes a splitting or separation.”

‘Smart’ means “containing a built-in processor.”

‘Unique identification code’ means a unique means of identifying a used article. In the present context, a UID is assigned to an article of a certain UPC, itself a unique identifier. Each UPC has a corresponding template, which is used to store product-related information, including a brief product description, MSRP, size (nominal length, width and height), and weight. The size and weight data are useful for determining shipping cost. MSRP can be a useful for setting the margin needed to make disposition decisions. Use of a UID as a data record label is useful for linking a variety of processes related to reverse logistics.

The foregoing is provided for illustrative and exemplary purposes; the present invention is not necessarily limited thereto. Rather, those skilled in the art will appreciate that various modifications, as well as adaptations to particular circumstances, are possible within the scope of the invention as herein shown and described.

What is claimed is:

1. A system for evaluating a graded used article identified by a UID, the system comprising:
a processor configured for:
receiving pre-determined grade data for the used article;
accessing graded used article-related data from at least one source;
performing mathematical operations on quantitative data; and
sending data on the used article to at least one device;
a database configured for receiving and storing graded used article-related data from a plurality of sources; and
a computer-readable memory configured for carrying out non-transitory computer-executable instructions to cause the processor to facilitate evaluating the used article, the computer-executable instructions comprising instructions that, when executed by the processor, implement one or more algorithms configured for:
acquiring graded used article-related price and availability data from a plurality of sources; and
evaluating the graded and identified used article.

2. The system of claim 1, wherein the processor is further configured for computing quantities related to price and availability data, specifically, weighted averages, wherein a set of weighting factors used in the computation is pre-determined by the respective sources of information or determined in relation to product availability from the respective source of information.

3. The system of claim 1, wherein the database is further configured for receiving the price and availability data in a plurality of forms, including character strings and image files, by a plurality of methods, including direct user input by a user interface and autonomous data transfer by a device interface, and from a plurality of sources, including historical sales records in electronic format and websites containing webpages that feature product-related information.

4. The system of claim 1, wherein the plurality of sources of article-related price and availability data includes webpages, the content of which can be acquired by:
connecting to an API and retrieving the desired data; and
obtaining a screenshot of a webpage, parsing the screenshot, using a machine-learning algorithm to identify the desired information in the parsed screenshot, and using OCR or a related method to convert the desired information into a corresponding character string.

5. The system of claim 1, wherein the processor is configured for performing basic mathematical operations on the price and availability data obtained from proprietary databases and websites, computing an average price and an availability for the identified used article, and assigning the computed average price and availability to the UID.

6. A method of operating a system for evaluating a graded used article identified by a UID, the method comprising:
receiving into a processor pre-determined grade data for the used article;
implementing computer code stored in memory to access, transfer and store in a database article-related price and availability data from a plurality of proprietary sources and a plurality of websites by APIs;
implementing computer code stored in memory to access a plurality of websites containing article-related price and availability data, obtain a screenshot of each website, and transfer the screenshots to the processor;
implementing a machine-learning algorithm and related computer code to parse each screenshot and identify the desired price and availability information in each parsed screenshot;
using OCR or a related method to convert the desired price and availability information into corresponding character strings;
evaluating the article by using the price and availability data obtained from proprietary databases and websites to compute an average price and an availability; and
assigning the calculated price and the availability to the UID.

7. A system for disposing a graded and evaluated used article identified by a UID, the system comprising:
a processor configured for:
receiving pre-determined evaluation data and margin data for the graded and evaluated used article;
accessing graded and evaluated used article-related data and margin from at least one source;
performing mathematical operations on quantitative data; and
sending data on the used to at least one device;
a database configured for receiving and storing graded and evaluated used article-related data from a plurality of sources; and
a computer-readable memory configured for carrying out non-transitory computer-executable instructions to cause the processor to facilitate disposing the used article, the computer-executable instructions comprising instructions that, when executed by the processor, implement one or more algorithms configured for:
acquiring evaluated used article-related cost data from a plurality of sources; and
disposing of the evaluated, graded and identified used article.

8. The system of claim 7, wherein the processor is further configured for computing quantities related to cost data, specifically, weighted averages, wherein the weighting factors are pre-determined by the respective sources of information, and quantities involving cost data, for example, net cost.

9. The system of claim 7, wherein the database is further configured for receiving cost data by a plurality of methods, including direct user input by a user interface and autonomous data transfer by a device interface, and from any useful source, for example, historical sales records in electronic format and websites containing webpages that feature product-related information.

10. The system of claim 7, wherein the plurality of sources of cost data includes webpages, the content of which is acquired by
connecting to APIs and retrieving the desired data; and
obtaining a screenshot of a webpage, parsing the screenshot, using a machine-learning algorithm to identify the desired information in the parsed screenshot, and using OCR or a related method to convert the desired information into a corresponding character string.

11. The system of claim 7, wherein the processor is configured for performing basic mathematical operations on the cost data obtained from proprietary databases and websites, computes an average cost for the graded and identified used article, and assigns a disposition to the UID.

12. A method of operating a system for disposing a graded and evaluated used article identified by a UID, the method comprising:
receiving into a processor pre-determined evaluation data and margin data for the graded and evaluated used article;
implementing computer code stored in memory to access from databases data concerning the costs of processing graded used articles, specifically, the costs of cleaning, accessorizing, warehousing in a specific location, picking from a specific location, and the associated labor costs;
implementing computer code stored in memory to access article-related cost data from websites by APIs, including shipping cost data;
implementing a machine-learning algorithm to extract article-related cost data from screenshots;
evaluating the cost of article processing by computing an average; and
selecting a disposition pathway for the used article by comparing price, cost and margin, wherein the disposition pathways are at least two of one or more return-to-shelf processes, one or more return-to-vendor processes, one or more business-to-consumer marketplaces, one or more business-to-business marketplaces, one or more liquidators, one or more refurbishers, one or more parts harvesters, and one or more landfill sites.

13. A system for repricing a graded, evaluated and disposed used article identified by a UID, the system comprising:
a processor configured for:
receiving pre-determined disposition data and parameter data for the graded, evaluated and disposed used article;
accessing evaluated, graded and disposed article-related data from at least one source;
performing mathematical operations on quantitative data; and
sending data on the used to at least one device;
a database configured for receiving and storing graded, evaluated and disposed used article-related data from a plurality of sources; and
a computer-readable memory configured for carrying out non-transitory computer-executable instructions to cause the processor to facilitate repricing the used article, the computer-executable instructions comprising instructions that, when executed by the processor, implement one or more algorithms configured for computing a new daily price for the disposed, evaluated, graded and identified used article.

14. The system of claim 13, wherein the pre-determined disposition data include an initial price.

15. The system of claim 13, wherein the processor is further configured for:
computing quantities related to price, specifically, weighted-average prices and new daily prices, based on pre-determined price data, weighting factors, inventory values, elapsed time values, and parameter settings;
assigning a new daily price to the UID; and
sending the new daily price to at least one marketplace.

16. The system of claim 15, wherein the new daily price is calculated by a machine-learning algorithm.

17. A method of operating a system for repricing a graded, evaluated and disposed used article identified by a UID, the method comprising:
receiving into a processor pre-determined disposition data for the graded, evaluated and disposed used article;
implementing computer code stored in memory to access UID-associated data from one or more computer storage locations, including all available historical daily price data for the used article in a specified time period, an initial quantity of like articles, a present quantity like articles, and pre-determined parameters used to calculate the daily price of the used article;
calculating a weighted-average price of the used article over the specified time period based on the historical daily price data and a given method of weighting the contribution of each daily price in the specified time period;
implementing a machine-learning algorithm to calculate a new daily price from the previous daily price, the weighted-average price, the number of units sold in a given time interval, and related parameters; and
sending the new daily price to specified marketplaces.

18. The method of claim 17, wherein the pre-determined disposition data include an initial price for the graded, evaluated and identified used article, the time when the article first entered inventory, the marketplaces where the article will be listed, and the times when listing of the article for sale is to begin for each marketplace.

19. The method of claim 17, wherein the machine learning system is configured for maximizing revenue and maximizing recovery.

20. The method of claim 17, wherein the listing price is computed from a weighted average of the daily calculated price over a number of days.
